(19) United States
(12) Patent Application Publication
(10) Pub. No.: US 2012/0214629 A1
(43) Pub. Date: Aug. 23, 2012

(54) Bicycle Sprocket

(76) Inventor: David Earle, Watsonville, CA (US)

(21) Appl. No.: 13/459,789

(22) Filed: Apr. 30, 2012

Related U.S. Application Data
(63) Continuation-in-part of application No. 12/817,835, filed on Jun. 17, 2010.

(51) Int. Cl. F16H 55/30

(52) U.S. Cl. 474/152

(57) ABSTRACT

A bicycle sprocket includes a sprocket body having a plurality of bottom edges along an outer periphery thereof, and a plurality of teeth. The bottom edges extends in a generally circumferential direction of the sprocket body. Each of the bottom edges is connected between two adjacent ones of the teeth. The central points of the bottom edges includes a first group of central points each spaced apart from the center of the sprocket body by a first distance, and a second group of central points each spaced apart from the center of the sprocket body by a second distance smaller than the first distance. The sprocket body further has a direction guiding groove extending inwardly from the outer periphery, permitting passage of a chain pin, and adjacent to the first group of the central points.

### CROSS-REFERENCE TO RELATED APPLICATION

This application is a continuation-in-part (CIP) of co-pending U.S. patent application Ser. No. 12/817,835, filed by the applicant on Jun. 17, 2010.

### BACKGROUND OF THE INVENTION

1. Field of the Invention

This invention relates to a bicycle sprocket, and more particularly to a sprocket for a multi-speed bicycle.

2. Description of the Related Art

An elliptical drive sprocket has been used to replace a circular drive sprocket so as to drive a multi-speed bicycle for increasing power output. However, it is difficult to move a bicycle chain between a larger elliptical drive sprocket and a smaller elliptical drive sprocket, thereby resulting in pedaling shock.

### SUMMARY OF THE INVENTION

The object of this invention is to provide a bicycle sprocket that is non-circular and that is configured to allow for smooth and speedy chain shifting.

Accordingly, a bicycle sprocket of this invention includes a sprocket body having plurality of bottom edges along an outer periphery thereof, and a plurality of teeth. The bottom edges extends in a generally circumferential direction of the sprocket body. Each of the bottom edges is connected between two adjacent ones of the teeth. The central points of the bottom edges includes a first group of central points each spaced apart from the center of the sprocket body by a first distance, and a second group of central points each spaced apart from the center of the sprocket body by a second distance smaller than the first distance. The sprocket body further has a direction guiding groove extending inwardly from the outer periphery, permitting passage of a chain pin, and adjacent to the first group of the central points.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a side view of the preferred embodiment of a bicycle sprocket according to this invention;

FIG. 2 is a side view of the preferred embodiment, illustrating that a chain pin of a bicycle chain is engaged within a direction guiding groove in the bicycle sprocket; and

FIG. 3 is a top view of the preferred embodiment, illustrating that the chain pin is engaged within the direction guiding groove.

### DETAILED DESCRIPTION OF THE PREFERRED EMBODIMENT

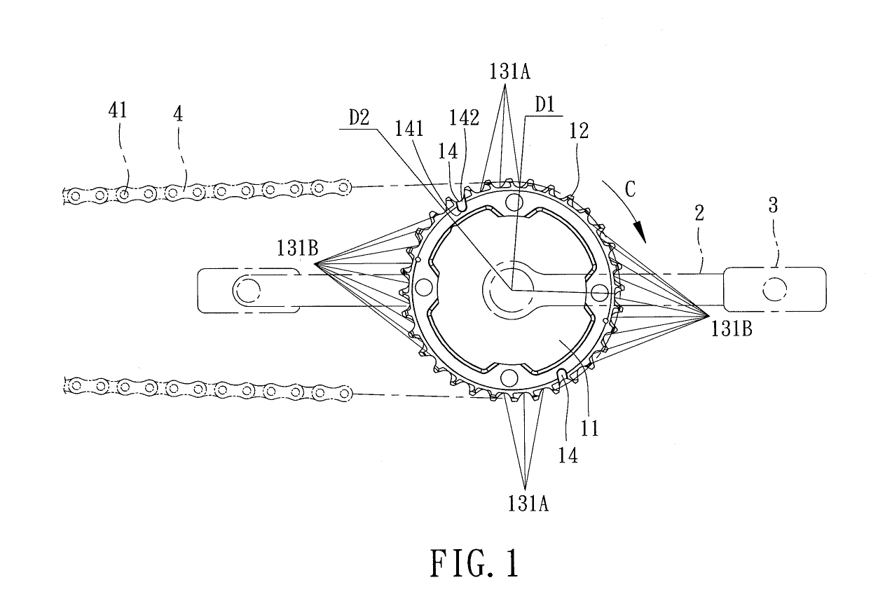

Referring to FIG. 1, the preferred embodiment of a bicycle sprocket 1 according to this invention is configured as a drive sprocket, and is connected to two cranks 2 and two pedals 3 in a known manner for driving a chain 4. The chain 4 includes a plurality of chain pins 41. The sprocket 1 forms a part of a bicycle, and is rotatable in a direction (C) to drive advancement of the bicycle.

The sprocket 1 includes a sprocket body 11 and a plurality of equidistant teeth 12 extending radially and outwardly from an outer periphery of the sprocket body 11. The sprocket body 11 has a plurality of spaced-apart bottom edges 13 along the outer periphery. The bottom edges 13 extend in a generally circumferential direction of the sprocket body 11. Each of the bottom edges 13 is connected between two adjacent ones of the teeth 12, and has a central point 131A, 131B.

The central points 131A, 131B of the bottom edges 13 include two diametrically opposed first groups of the central points 131A, and two diametrically opposed second groups of the central points 131B. In this embodiment, the number of each first group of the central points 131A is three, and the number of each second group of the central points 131B is more than three.

Each of the first groups of the central points 131A is spaced apart from the center of the sprocket body 11 by a first distance D1 of 60.895 mm. Each of the second groups of the central points 131B is spaced apart from the center of the sprocket body 11 by a second distance D2 of 60.78 mm.

Preferably, the difference between the first and second distances D1, D2 is smaller than 2 mm.

As illustrated, when each of the cranks 2 is in a horizontal position, one first group of the central points 131A is disposed under the other first group of the central points 131A. In this condition, through operation of a derailleur (not shown), the chain 4 can be moved easily between a larger sprocket 1 and a smaller sprocket 1, thereby resulting in smooth and speedy chain shifting. Thus, the object of this invention is achieved.

To further facilitate smooth and speedy shifting of the chain 4 from the larger sprocket 1 onto the smaller sprocket 1, the sprocket body 11 is formed with two direction guiding grooves 14 in a side surface thereof, which are diametrically opposite to each other, which are adjacent to the first groups of the central points 131A, respectively, and which extend inwardly from the outer periphery of the sprocket body 11. In this embodiment, each first group of the central points 131A are disposed ahead of an adjacent one of the direction guiding grooves 14 along the direction (C).

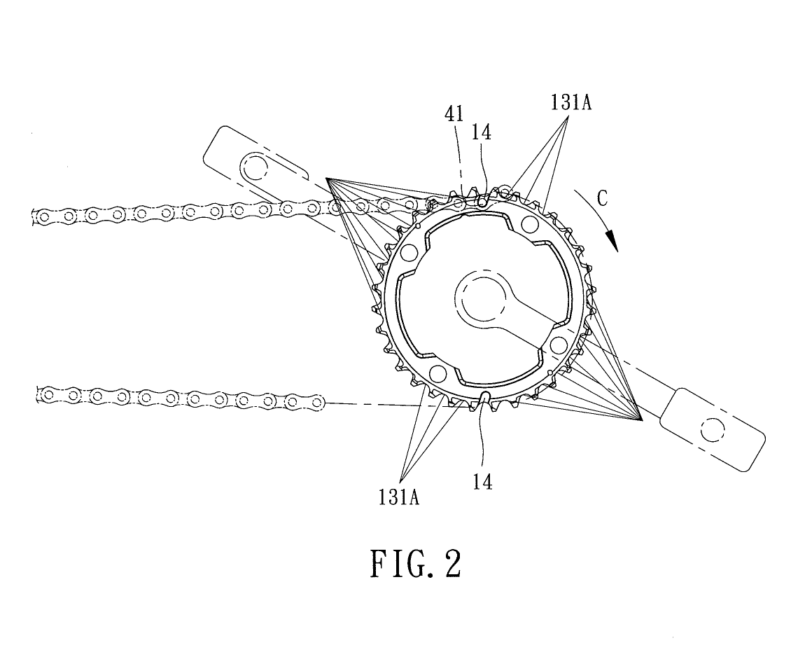

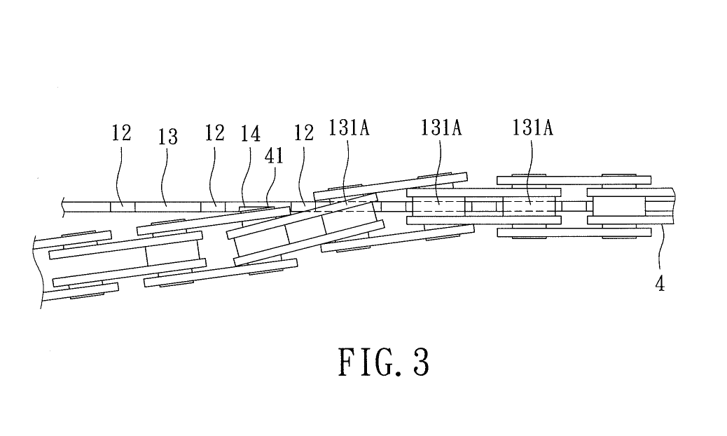

Each of the direction guiding grooves 14 has a closed inner end 141 distal from the outer periphery, and an open outer end 142 that is proximate to the outer periphery, that is opposite to the inner end 141, that is disposed at one of the bottom edges 13 between two corresponding adjacent ones of the teeth 12, and that is inclined from the inner end 141 toward a leading one of the two corresponding adjacent ones of the teeth 12 along the direction (C). As such, with further reference to FIGS. 2 and 3, when the chain 4 shifts from the larger sprocket 1 onto the smaller sprocket 1, two of the chain pins 41 pass respectively through the direction guiding grooves 14 at a time to guide the two chain pins 41 to contact two of the first groups of the central points 131A, respectively.

With this invention thus explained, it is apparent that numerous modifications and variations can be made without departing from the scope and spirit of this invention. It is therefore intended that this invention be limited only as indicated by the appended claims.

I claim:

1. A bicycle sprocket adapted to be connected to a chain including a plurality of chain pins, said bicycle sprocket comprising a sprocket body and a plurality of equidistant teeth extending radially and outwardly from an outer periphery of said sprocket body, said sprocket body having a plurality of spaced-apart bottom edges along the outer periphery, said bottom edges extending in a generally circumferential direction of said sprocket body, each of said bottom edges being connected between two adjacent ones of said teeth and having a central point, said central points of said bottom edges including at least one first group of central points and at least one second group of central points, each of said first group of said central points being spaced apart from a center of said sprocket body by a first distance, each of said second group of said central points being spaced apart from the center of said sprocket body by a second distance that is smaller than the first distance, wherein said sprocket body further has at least one direction guiding groove that extends inwardly from said outer periphery, that is adapted for passage of one of the chain pins, and that is adjacent to said first group of said central points.

2. The bicycle sprocket as claimed in claim 1, adapted to form a part of a bicycle and adapted to be rotatable in a direction to drive advancement of the bicycle, wherein said direction guiding groove in said sprocket body has an inner end distal from said outer periphery, and an open outer end that is proximate to said outer periphery and that is opposite to said inner end, said outer end being disposed at one of said bottom edges between two corresponding adjacent ones of said teeth and being inclined from said inner end toward a leading one of said corresponding adjacent ones of said teeth along the direction.

3. The bicycle sprocket as claimed in claim 2, wherein said first group of said central points are disposed ahead of said direction guiding groove along the direction.

4. The bicycle sprocket as claimed in claim 2, wherein said said sprocket body has two said direction guiding grooves, said central points of said bottom edges including two diametrically opposed said first groups of said central points and two diametrically opposed said second groups of said central points, the number of each said first group of said central points being three, the number of each said second group of said central points being more than three.

5. The bicycle sprocket as claimed in claim 2, wherein said inner end of said direction guiding groove is closed.

6. The bicycle sprocket as claimed in claim 2, wherein said sprocket body further has a side surface, said direction guiding groove being formed in said side surface.
